(19) United States
(12) Patent Application Publication
(10) Pub. No.: US 2022/0073424 A1
(43) Pub. Date: Mar. 10, 2022

(54) METHOD FOR THE SELECTIVE ETCHING OF A LAYER OR A STACK OF LAYERS ON A GLASS SUBSTRATE

(71) Applicant: SAINT-GOBAIN GLASS FRANCE, COURBEVOIE (FR)

(72) Inventor: Laurent MAILLAUD, MASSY (FR)

(21) Appl. No.: 17/291,179

(22) PCT Filed: Nov. 14, 2018
(86) PCT No.: PCT/FR2018/052836

§ 371 Date: May 4, 2021

(51) Int. Cl. C03C 17/42; C03C 17/36; C03B 27/012; C03B 23/03

(52) U.S. Cl. CPC C03C 17/42; C03C 17/3644; C03C 17/3681; C03C 17/366; C03C 17/3626; C03C 2218/355; C03B 23/0307; C03C 2218/156; C03C 2218/116; C03C 2218/328; C03C 2218/34; C03B 27/012

(57) ABSTRACT

A process for depositing on a glass substrate a mineral functional layer or stack, includes depositing on the substrate a laser-crosslinkable organic photosensitive resin liquid composition, locally crosslinking the resin by a laser, removing the non-crosslinked liquid composition, depositing on the substrate thus coated a mineral functional layer or stack, and then performing combustion of the crosslinked solid resin via a heat treatment, completing its removal and that of the mineral layer or stack via a mechanical action, so as to obtain the mineral layer or stack in a pattern corresponding to the negative of that made with the crosslinked solid resin.

The invention relates to a glazing onto which has been deposited via a process of physical vapor deposition (PVD) under vacuum, mainly cathode-enhanced magnetron sputtering, plasma-enhanced chemical vapor deposition (PECVD) or evaporation or a liquid deposition process, one or more thin layers having spatial structuring at scales which may vary from several cm to less than 10 μm.

The products targeted are varied: silver layers (solar control, low-emissive, electromagnetic shielding, heating), layers modifying the level of reflection in the visible region (antireflection or mirror layers), transparent or non-transparent electrode layers, electrochromic, electroluminescent, anti-iridescent, antisoiling, scratch-resistant or magnetic layers, colored or absorbent layers for modifying the transmittance in the visible region for esthetic purposes.

The products targeted are in particular stacks deposited by magnetron sputtering.

Glazings having a capacity for reflecting both near-IR and/or far-IR waves, as is common in thermal-control glazings, will be thought of, but not exclusively. The function provided is, in this case, either the drastic reduction of the emissivity of the surface of the glazing (thermal insulation) or a substantial reduction in the amount of solar energy passing through the glazing assembly (solar control).

Similarly, glazings covered with a conductive layer which acts as an electrode—for example for a heating function (eglass for building applications, heated windscreen or side windows for motor vehicle or aeronautical applications) or which can serve as an antenna for picking up electromagnetic waves, will be considered.

A particular case concerns the microwave band in the GHz region (100 μm<I<1 m) which finds applications for radio transmissions (GSM, satellite, radar, etc.). Specifically, the possibility of structuring the layer at a scale less than that of the wavelength gives access to the range of metamaterials in which the electromagnetic transmission can be modulated.

For these various functions (antenna, heating, thermal control), the highly conductive and non-earthed layer brings about significant attenuation of high-frequency electromagnetic waves and it is difficult to ensure the compromise between thermal control (hereinabove the case of reducing heating in a vehicle) and good reception of communication signals. The standard attenuation on a windscreen of a thermal control layer may be, for example, from −30 to −45 dB approximately between 0.4 and 5 GHz.

This compatibility of the thermal functions with the transparency to communication waves (for example 2G/3G/4G) is highly demanded for motor vehicle applications and is increasingly demanded for buildings which do not have relays.

There are currently two solutions for overcoming this difficulty: the thermal control function may be provided not by a conductive thin layer but by a polyvinyl butyral (PVB) or other interlayer containing nanoparticles of a conductive compound such as tin-doped indium oxide (ITO, meaning indium tin oxide), for example. In this case, the thermal control is provided by absorption rather than by reflection of the energetic part of the spectrum. This solution is possible only for solar control, and is sparingly efficient relative to the reflection solution and requires laminated glazing.

The second solution consists in etching the silver layer after deposition so as to selectively remove the silver on strips that are thin enough (100 μm) to be barely perceptible to the eye and spaced from each other by a few mm depending on the wavelengths whose transmission it is desired to promote. Complex patterns may be used for this application fully in the face. Representatives of this technique are in particular WO 99/54961 A1 and WO 2014/033007 A1.

In addition, the heating efficiency of a conductive layer depends on its surface resistance R_{sq} or R_{□}, the voltage between the electrodes, but also the distance between the electrodes. For building applications, this dependency poses a problem since, for the same power supply, an electrical resistance of the glazing is required for each size of heating zone. One solution may consist in etching once more, for example, a silver base layer so as to modulate its overall surface resistance to enable it to be compatible with the distance between electrodes and the desired surface heating power.

Finally, a silver-based glazing may be functionalized in the form of an antenna on condition that the electromagnetic decoupling of the layer with the car body, for example, is performed. This operation is also achieved by etching.

Alternative selective etching methods are essentially derived from the microelectronics industry. Some of them employ temporary layers, others consist of direct etching.

In the microelectronics or photolithography industry: use of temporary layers to serve as masks for selective acid attack. Photolithography allows very fine etching (45-90 nm nowadays industrially), but remains limited to the size of the masks, which at the present time is limited by the size of the optics.

Laser engraving of the conductive layer is performed by a spot engraving laser which sublimes the thin-layer stack by sweeping with the beam. This operation is of low production efficiency on large-sized glazings and requires heavy investment with regard to the surfaces treated.

Ion-impact or electron-impact etching has the same limitations as laser engraving in terms of production efficiency.

Other etching methods come from conventional printing.

At the present time, inkjet printing techniques still remain limited for sizes greater than 10 m² to printing times of more than a minute.

Other techniques may be favored over screen printing when a resolution scale of less than 50 μm is sought: the reason for this is that this process affords relatively mediocre edge qualities at these small scales.

The aim of the invention is thus the provision of functional glazings which allow radio frequencies to pass through. The term “functional glazing” means herein a thermal-control heated antenna glazing, or the like, a glazing with electrically conductive or non-conductive layer(s), and also all the other glazings mentioned previously. Radio frequencies are high-frequency electromagnetic waves, in the gigahertz region, and find applications in radio transmissions (GSM, satellite, radar, etc.) and communication (for example 2G/3G/4G).

To this end, one subject of the invention is a process for depositing on a glass substrate an essentially mineral functional layer or stack of layers, characterized in that it comprises the steps consisting in
depositing on the substrate a precursor liquid composition of a laser-crosslinkable essentially organic photosensitive resin, in
locally crosslinking the resin by means of a laser,
removing the non-crosslinked liquid composition,
depositing on the substrate thus coated an essentially mineral functional layer or stack of layers, and then
subjecting the assembly to a heat treatment so as to effect combustion of the crosslinked solid resin, completing the removal of said resin and of the essentially mineral functional layer or stack of layers covering it by a mechanical action such as wiping with a cloth and/or blowing with gas and/or washing, the heat treatment not being necessary if the width of the crosslinked solid resin pattern is at most equal to 40 μm, so as to obtain the essentially mineral functional layer or stack of layers in a pattern corresponding to the negative of that made with the crosslinked solid resin.

Laser crosslinking of the resin makes it possible to harden it in an extremely fine line, with a width of the order of a few tens of microns or even less, in general between 5 and 100 μm. In the case of lines with a width of 40 μm at most, a heat treatment is not necessary, the line of organic resin and the magnetron layer or stack which covers it may be removed solely by techniques of wiping, blowing with gas, washing, etc. However, a heat treatment may be performed in this case also, in particular in order to give the glass substrate improved mechanical properties.

The technique according to the invention affords an excellent quality of the substrate and in particular of the edges of zones not coated with the organic coating and covered with the mineral layer(s) (sharpness, resolution).

The process makes it possible to produce on an industrial line, on a substrate of large area, an essentially organic coating pattern. The reduced cycle time makes it possible to validate the industrially applicable nature.

According to preferred characteristics of the process of the invention:
the deposition of the precursor liquid composition of a photosensitive resin is performed using a Mayer rod, a film spreader, a spin coater, by dipping or the like;
the precursor liquid composition of a photosensitive resin is of the type that can be used for photolithography, in particular in the microelectronics field, and comprises an epoxy resin in a solvent such as cyclopentanone, a monomer and/or oligomer of acrylate, epoxyacrylate, polyester acrylate, polyurethane acrylate, polyvinylpyrrolidone+EDTA composition, polyamide, polyvinyl butyral, positive photosensitive resin of diazonaphthoquinone-novolac type, any organic material that is crosslinkable under ultraviolet, infrared or visible radiation, alone or as a mixture of several thereof;
the precursor liquid composition of a photosensitive resin is deposited on the substrate in a thickness of between 1 and 40 μm; in the context of the invention, this may be considered as approximately equivalent to the thickness of the solid resin after crosslinking; this thickness must be sufficient to ensure the removal of the magnetron layer or stack in conformity with sharp, sufficiently resolved edges;
the crosslinked solid resin pattern comprises lines with widths of between 5 and 20 μm; below 5 μm, the loss of the electromagnetic wave signal is too large to achieve the aim of the invention; above 20 μm, in particular at and above 30, the ablation line of the magnetron layer or stack begins to be visible, even with difficulty, depending on the light or contrast conditions;
to remove the non-crosslinked liquid composition, the coated substrate is immersed in a good solvent for the non-crosslinked liquid composition, it is then extracted therefrom, good solvent is then sprayed delicately onto the substrate, the surface of the substrate is then washed by delicately spraying with a solvent such as isopropanol to remove the good solvent therefrom and in the vicinity of the crosslinked solid resin pattern, and the substrate and the crosslinked solid resin pattern are then dried with a stream of gas such as nitrogen or air;
the essentially mineral functional layer or stack of layers is formed by a process of physical vapor deposition (PVD) under vacuum such as cathode sputtering, in particular cathode-enhanced magnetron sputtering, evaporation or plasma-enhanced chemical vapor deposition (PECVD) or via a liquid route;
the essentially mineral functional layer or stack of layers is constituted of Ag, transparent conductive oxide (TCO) such as tin-doped indium oxide (ITO), zinc-doped indium oxide (IZO), ZnO:Al, Ga, cadmium stannate, Al, Nb, Cu, Au, a compound of Si and N such as Si₃N₄, an afferent dielectric stack, alone or as a combination of several thereof;
the thickness of the essentially mineral functional layer or stack of layers is at least 10 times smaller than that of the crosslinked solid resin pattern, and is in particular at most equal to 300, preferably 200 and most particularly 150 nm; this makes it possible to remove therefrom the fraction covering the crosslinked solid resin as sharp edges, as already mentioned above.

Since the glass can no longer be cut once it has been tempered, it may, in certain applications, for example for buildings, be stored and then cut, edged, etc. before tempering. This glazing may be sold in the form as obtained, mainly in this case with the crosslinked solid resin pattern and the magnetron layer or stack removed subsequently with tempering by a transformer, in accordance with the process of the invention.

Preferably, the heat treatment forms part of a thermal tempering of the glass substrate. During tempering, the resin disappears by combustion and consequently removes the essentially mineral functional layer or stack of layers, which may be conductive at the places of the resin patterns, which brings about the desired selective etching.

In one particular embodiment, the heat treatment forms part of a bending of the glass substrate, in particular press bending. In this case, a preliminary heat treatment brings about combustion of the resin, and any pulverulent resin combustion residues and the fraction of the magnetron layer or stack covering the crosslinked resin pattern are then removed via any suitable means, before the pressing tools come into contact with the glass substrate.

According to one variant of the process, after the deposition of the essentially mineral functional layer or stack of layers, at least one essentially organic photosensitive resin—essentially mineral functional layer or stack of layers sequence is deposited again. This deposition is preferably performed before the heat treatment for the combustion of the essentially organic resin that is closest to the substrate, and a subsequent heat treatment will produce the combustion of several superposed essentially organic resins and also the subsequent removal of several essentially mineral functional layers or stacks of layers covering them. However, the deposition of essentially organic resin—essentially mineral functional layer or stack of layers sequences, starting from the second sequence, after the combustion heat treatment of the first essentially organic resin and wiping or removal by blowing with gas of its organic residues and of the mineral residues covering them, also forms part of the invention.

The glass substrate obtained via the process of the invention is also capable of being integrated into a laminated glazing or other laminated composite product, and/or into a multiple glazing.

Other subjects of the invention consist of
a glass substrate coated with at least one sequence constituted of
   a solid essentially organic photosensitive resin which is crosslinked, over a part but not all of its surface, in accordance with a pattern comprising lines with widths of between 5 and 100 μm and heights of between 1 and 40 μm,
   covered with an essentially mineral functional layer or stack of layers with thicknesses at most equal to 300 nm, and which extends substantially over the entire surface of the substrate;
the application of a glazing with an essentially mineral functional layer or stack of layers, obtained via a process as described previously, as functional glazing with decreased transmission attenuation of waves with frequencies of between 0.4 and 5 GHz; it may be a thermal control or heated transparent glazing (motor vehicle, transportation and building applications), a heated glazing with adapted resistance per square (motor vehicle, transportation and building), an electrically conductive glazing already structured as an antenna (motor vehicle and transportation), a solar control glazing of constant selectivity at least equal to 1.6 and of very high light transmission LT, a low-cost masking glazing (alternative to edging with a grinding wheel), a glazing of Day Lighting type with LT modulated according to the height, a glazing with negative index in the microwave range (GHz) for antiradar, GSM, etc. applications, a large-sized glazing as a substrate with structured electrodes.

The invention will be understood more clearly in the light of the example that follows.

### EXAMPLE 1

A uniform thickness of a precursor liquid composition of an organic photosensitive resin, sold by the company MicroChem Corp under the registered brand name MicroChem® SU-8 2015, is applied by spin coating to a 15 cm×15 cm glass substrate 4 mm thick, sold by the company Saint-Gobain Glass under the registered brand name Planiclear®.

This liquid composition contains, as mass percentages:
epoxy resin (CAS No. 28906-96-9): 3-75%
cyclopentanone (CAS No. 120-92-3): 23-96%
hexafluoroantimonate salt (CAS No. 71449-78-0): 0.3-5%
propylene carbonate (CAS No. 108-32-7): 0.3-5%
triarylsulfonium salt (CAS No. 89452-37-9): 0.3-5%

A uniform liquid thickness of 21 μm is deposited at a spin-coating spin speed of 2000 rpm. A spin coater machine of registered brand name Semiconductor Production Systems Europe® (SPS) sold under the reference SPIN150 is used.

The resin is crosslinked locally using a laser sold under the registered brand name Trumpf®, TruMark Station 5000 model. The laser is used at a power of 100%, a focal length of 4.3 mm, a speed of 1000 mm/s and a frequency of 70000 Hz.

The substrate, the crosslinked solid resin pattern and the non-crosslinked liquid resin are placed for one minute in a bath of good solvent for the non-crosslinked resin. It is, in mass percentages:
more than 99.5% of 1-methoxy-2-propanol acetate (CAS No. 108-65-6) and
less than 0.5% of 2-methoxy-1-propanol acetate (CAS No. 70657-70-4).

The substrate, the crosslinked solid resin pattern and the non-crosslinked liquid resin are then removed from the bath and good solvent is then delicately sprayed on using a pipette so as to complete the washing (removal) of the non-crosslinked liquid resin. The good solvent is washed from the surface of the substrate and of the crosslinked solid resin pattern with isopropanol using a pipette. Finally, the substrate and the crosslinked solid resin pattern are dried with a stream of nitrogen.

The lines of the crosslinked solid resin pattern have a width of 30±2 μm and a height of 20±5 μm. The crosslinked resin pattern is a square lattice network with a side length of 3 mm (distance between the centers of two consecutive parallel lines).

A stack of thin layers is deposited in a compliant manner by cathode-enhanced magnetron sputtering onto the glass+crosslinked solid resin pattern system. This stack of thin layers has the following constitution, in which the thicknesses are in nm: Si₃N_{4 20/}SnZnO 6/ZnO 7/NiCr 0.5/Ag 9/NiCr 0.5/ZnO 5/Si₃N₄ 40/SnZnO 30/ZnO 5/NiCr 0.5/Ag 14/NiCr 0.5/ZnO 5/Si₃N₄ 28. The ZnO layers are nonporous. This stack with a thermal control function is temperable.

The glass substrate, the crosslinked solid resin pattern and the stack of mineral layers are tempered in a thermal annealing furnace sold under the registered brand name Nabertherm® (N41/H model), at 650° C. for 10 minutes, so as to give the substrate and its stack of mineral layers their final mechanical properties. Tempering also makes it possible to partially remove the crosslinked solid resin pattern, thus detaching the mineral layers which cover it. A mechanical action should be applied so as to fully remove the resin residues; to this end, this mechanical action is sufficient in the absence of the heat treatment since the lines of the crosslinked solid resin pattern have a width of less than 40 μm.

The final product has the stack of thin layers described above structured in a pattern corresponding to the negative of that made with the resin.

The transmission of electromagnetic waves through this glazing and through a comparative glazing, which differs from the glazing of the invention only in the presence of the stack of magnetron mineral layers over its entire surface, is measured.

For frequencies of 0.9, or 2.4, or 5 GHz, respectively, the transmission attenuation of the glazing of the invention, including the magnetron stack except in a grating pattern of 3 mm×3 mm, with a line width of 30 μm, is −9, or −19, or −25 dB, respectively. For the comparative glazing without the grating pattern free of the magnetron stack, it is −25, or −40, or −54 dB, respectively.

Thus, the invention provides a functional glazing with decreased transmission attenuation of waves with frequencies of between 0.4 and 5 GHz.

1. A process for depositing on a glass substrate an essentially mineral functional layer or stack of layers, the process comprising:
depositing on the glass substrate a precursor liquid composition of a laser-crosslinkable essentially organic photosensitive resin,
locally crosslinking the resin by a laser,
removing the non-crosslinked liquid composition,
depositing on the glass substrate thus coated an essentially mineral functional layer or stack of layers, and then
subjecting an assembly formed by the glass substrate thus coated and the essentially mineral functional layer or stack of layers to a heat treatment so as to effect combustion of the crosslinked solid resin, completing a removal of said resin and of the essentially mineral functional layer or stack of layers covering it by a mechanical action, the heat treatment not being necessary if the width of the crosslinked solid resin pattern is at most equal to 40 μm,
so as to obtain the essentially mineral functional layer or stack of layers in a pattern corresponding to a negative of that made with the crosslinked solid resin.

2. The process as claimed in claim 1, wherein the deposition of the precursor liquid composition of a photosensitive resin is performed using a Mayer rod, a film spreader, a spin coater, or by dipping.

3. The process as claimed in claim 2, wherein the precursor liquid composition of a photosensitive resin is usable for photolithography and comprises an epoxy resin in a solvent or any organic material that is crosslinkable under ultraviolet, infrared or visible radiation, alone or as a mixture of several thereof.

4. The process as claimed in claim 1, wherein the precursor liquid composition of a photosensitive resin is deposited on the substrate in a thickness of between 1 and 40 μm.

5. The process as claimed in claim 1, wherein the crosslinked solid resin pattern comprises lines with widths of between 5 and 20 μm.

6. The process as claimed in claim 1, wherein, to remove the non-crosslinked liquid composition, the coated glass substrate is immersed in a good solvent for the non-crosslinked liquid composition, it is then extracted therefrom, good solvent is then sprayed delicately onto the substrate, a surface of the glass substrate is then washed by delicately spraying with a solvent to remove the good solvent therefrom and in the vicinity of the crosslinked solid resin pattern, and the glass substrate and the crosslinked solid resin pattern are then dried with a stream of gas.

7. The process as claimed in claim 1, wherein the essentially mineral functional layer or stack of layers is formed by a process of physical vapor deposition (PVD) under vacuum, evaporation or plasma-enhanced chemical vapor deposition (PECVD) or via a liquid route.

8. The process as claimed in claim 7, wherein the essentially mineral functional layer or stack of layers is constituted of Ag, transparent conductive oxide (TCO) Al, Nb, Cu, Au, a compound of Si and N such as Si₃N₄, an afferent dielectric stack, alone or as a combination of several thereof.

9. The process as claimed in claim 1, wherein a thickness of the essentially mineral functional layer or stack of layers is at least 10 times smaller than that of the crosslinked solid resin pattern.

10. The process as claimed in claim 1, wherein the heat treatment forms part of a thermal tempering of the glass substrate.

11. The process as claimed in claim 1, wherein the heat treatment forms part of a bending of the glass substrate.

12. The process as claimed in claim 11, wherein the bending is performed by pressing.

13. The process as claimed in claim 1, wherein, after the deposition of the essentially mineral functional layer or stack of layers, at least one essentially organic photosensitive resin—essentially mineral functional layer or stack of layers sequence is deposited again.

14. A glass substrate coated with at least one sequence comprising:
a solid essentially organic photosensitive resin which is crosslinked, over a part but not all of its surface, in accordance with a pattern comprising lines with widths of between 5 and 100 μm and heights of between 1 and 40 μm;
covered with an essentially mineral functional layer or stack of layers with thicknesses at most equal to 300 nm, and which extends substantially over the entire surface of the substrate.

15. A method comprising utilizing a glazing with an essentially mineral functional layer or stack of layers, obtained via a process as claimed in claim 1, as a functional glazing with decreased transmission attenuation of waves with frequencies of between 0.4 and 5 GHz.

16. The process as claimed in claim 1, wherein the resin and the essentially mineral functional layer or stack of layers are removed by wiping with a cloth and/or blowing with gas and/or washing.

17. The process as claimed in claim 3, wherein the photosensitive resin comprises cyclopentanone, a monomer and/or oligomer of acrylate, epoxyacrylate, polyester acrylate, polyurethane acrylate, polyvinylpyrrolidone+EDTA composition, polyamide, polyvinyl butyral, positive photosensitive resin of diazonaphthoquinone-novolac type.

18. The process as claimed in claim 6, wherein the solvent is isopropanol and the stream of gas is nitrogen or air.

19. The process as claimed in claim 7, wherein the essentially mineral functional layer or stack of layers is formed by cathode-enhanced magnetron sputtering.

20. The process as claimed in claim 9, wherein the thickness of the essentially mineral functional layer or stack of layers is at most equal to 300 nm.
